(19) United States
(12) Patent Application Publication
(10) Pub. No.: US 2026/0000053 A1
(43) Pub. Date: Jan. 1, 2026

(54) ANTI-BARKING DEVICE WITH BONE CONDUCTION MICROPHONES

(71) Applicant: Zhican HUANG, Quanzhou (CN)

(72) Inventors: Zhican HUANG, Quanzhou (CN); Baoyin HUANG, Quanzhou (CN); Xiaowei ZHANG, Quanzhou (CN)

(21) Appl. No.: 18/757,559

(22) Filed: Jun. 28, 2024

(51) Int. Cl. A01K 15/02

(52) U.S. Cl. CPC A01K 15/022

(57) ABSTRACT

Disclosed in the present invention is an anti-barking device with bone conduction microphones, including: a main body shell structure internally provided with an electrical assembly; the electrical assembly configured to receive pet status information; elastic arms configured to ensure that the bone conduction microphones are fitted with a pet; the bone conduction microphones configured to sense bone vibrations generated during barking of the pet; and electric shock heads configured to provide electric shock stimulation. The anti-barking device in the present invention is provided with the bone conduction microphones, and the bone conduction microphones are closely fitted with the neck skin of the pet by means of the elastic arms, so that the bone conduction microphones can capture the vibrations during the barking of the pet. The microprocessor can control the electric shock heads to emit the electric shock stimulation to the pet, thereby avoiding bark interference by other pets.

### TECHNICAL FIELD

The present invention relates to the technical field of pet supplies, in particular to an anti-barking device with bone conduction microphones.

### BACKGROUND ART

With the improvement of people's living standards and the development of technologies, the need for keeping pets grows rapidly. As one of the best friends of humans, the pets can accompany us to pass the lonely time and can offer emotional support and comfort. By means of interactions with the pets, the pressure levels of people can be reduced, and the mental health can be promoted. In addition, keeping the pets having the needs for outdoor activities can promote owners to increase outdoor activities, thereby improving their physical health, and the outdoor activities are beneficial to the physical health of the pets. Time, energy and love are needed during pet keeping. By means of the interactions with the pets, people can learn how to take care of others better and can enhance their empathy, which is beneficial to cultivating the responsibility and love of the owners, and this is common during early childhood growth education.

By means of training, the pets can learn basic rules and boundaries, which is beneficial to maintenance of the harmony between families and social environments, avoids contradictions and conflicts caused by improper behaviors of the pets, helps the pets better adapt to the lifestyle of the human society, and reduces troubles and limitations caused by behavior problems.

Barking is the nature of most pets, particularly common pets such as dogs. Appropriate barking is necessary for the pets, but excessive barking is meaningless for the pets. Meanwhile, long-time barking is harmful to vocal cords of the pets. In addition, the unnecessary and excessive barking not only causes troubles to the owners of the pets, but may also affect neighbors and communities, resulting in complaints and disputes. Therefore, the pets need to be trained to reduce such situations, and this is beneficial to maintenance of the community harmony.

Existing anti-barking devices for pets are usually provided with microphones only, and when the microphones receive barks, the anti-barking devices stimulate the pets to prevent the pets from further barking. However, such anti-barking devices cannot distinguish whether sound sources of the barks are the pets needing to be trained, so that stimulation also occurs when the devices receive barks of other pets during training, the pets cannot receive appropriate training signals, and the training effect of the pets is affected.

### SUMMARY OF THE INVENTION

In order to solve the technical problem that triggering of existing anti-barking devices for pets for stimulation is not only limited to pets to be trained, the present invention provides an anti-barking device with bone conduction microphones. The anti-barking device is provided with elastic arms with the bone conduction microphones, and the bone conduction microphones are closely fitted with the neck skin of the pet by means of the elastic arms, so that the bone conduction microphones can capture vibrations during barking of the pet. The bone conduction microphones convert vibration signals into electric signals and send the electric signals to a microprocessor, and the microprocessor generates warning signals according to the electric signals, so as to control electric shock heads to emit electric shock stimulation to the pet, thereby achieving the effect of training the pet, and avoiding bark interference by other pets.

The technical solution of the present invention is as follows:

the anti-barking device with the bone conduction microphones, comprising:

a main body shell structure configured to provide a mounting base and protection for other functional components and internally provided with an electrical assembly;

the electrical assembly configured to receive pet status information and real-time feedback;

the elastic arms configured to ensure that the bone conduction microphones are stably fitted with the pet;

the bone conduction microphones arranged at tail ends of the elastic arms and configured to sense the bone vibrations generated during the barking of the pet and convert the vibration signals into the electric signals; and

the electric shock heads configured to provide the electric shock stimulation during the barking of the pet.

With regard to the anti-barking device with the bone conduction microphones, the main body shell structure comprises an upper shell and a lower shell, the upper shell and the lower shell are connected to form an enclosing space, and the enclosing space is internally provided with the electrical assembly.

Further, a panel structure is arranged on the upper shell of the main body shell structure.

Further, a display screen is arranged on the upper shell of the main body shell structure.

Further, a connection between the upper shell and the lower shell is a threaded connection of bolts and screw holes.

With regard to the anti-barking device with the bone conduction microphones, bone conduction supports are arranged on one surface of the main body shell structure close to the skin of the pet, and the bone conduction supports are configured for the mounting base for the elastic arms and the electric shock heads and the protection of related electronic components.

Further, symmetric concave structures are arranged on one surface of the main body shell structure close to the skin of the pet, and the bone conduction supports are arranged outside the concave structures, so that enclosing spaces are formed between the bone conduction supports and the concave structures.

Further, a plurality of connection holes are formed in the concave structures, and connection wires of electronic components in the enclosing spaces formed between the bone conduction supports and the concave structures and the electrical assembly in an internal space of the main body shell structure pass through the connection holes.

Further, a first waterproof sealing ring is arranged between each of the bone conduction supports and the main body shell structure. An edge of each of the concave structures is further recessed to form an annular groove, the first waterproof sealing ring is arranged in the annular groove, so that waterproof sealing is achieved between the bone conduction support and the main body shell structure.

With regard to the anti-barking device with the bone conduction microphones, lace openings are formed on two sides of the main body shell structure.

With regard to the anti-barking device with the bone conduction microphones, the electrical assembly comprises:

the microprocessor configured to receive the electric signals sent by the bone conduction microphones and send the warning signals to the electric shock heads.

Further, the microprocessor further receives matching signals fed back by an infrared wearing detection module, when the infrared wearing detection module sends a signal of successful matching, the microprocessor starts to work and begins to process the received electric signals sent by the bone conduction microphones, and when the infrared wearing detection module sends a signal of unsuccessful matching, the microprocessor does not start to work.

Further, the microprocessor also sends the warning signals to the display screen.

Further, the electrical assembly further comprises a power source configured to supply power.

Furthermore, the electrical assembly further comprises a transformer configured to change a power supply voltage of the power source for a certain component.

With regard to the anti-barking device with the bone conduction microphones, each of the elastic arms is of a shape-adjustable flexible hollow structure.

With regard to the anti-barking device with the bone conduction microphones, an electrical connection wire of each of the bone conduction microphones passes through an internal hollow structure of the respective elastic arm to extend into the enclosing space between the respective bone conduction support and the respective concave structure and is electrically connected to the electronic components in the bone conduction support.

Further, an inner cavity of each elastic arm is in communication with the respective bone conduction support.

Further, there are eight elastic arms.

With regard to the anti-barking device with the bone conduction microphones, each of the bone conduction microphones comprises:

a piezoelectric element configured to sense the vibrations; and

a signal processing circuit configured to convert the vibration signals obtained by the piezoelectric element into the electric signals, and connected to the electronic components in the respective bone conduction support by a connection wire passing through the respective elastic arm.

With regard to the anti-barking device with the bone conduction microphones, each of the electric shock heads usually comprises:

an electrode configured to transmit the electric shock stimulation to the pet;

an insulator configured to coat or isolate the electrode; and

an electric shock control circuit configured to control strength and a duration of electric shocks of the electrode.

Further, each of the electric shock control circuits controls the strength and the duration of the electric shocks sent by the respective electric shock head, if a safety control threshold value is reached, the electrode of the electric shock head is suspended for certain set time, and the mode is also capable of protecting the electric shock head against overwork and prolonging the product life of the electric shock head.

With regard to the anti-barking device with the bone conduction microphones, each of the electric shock heads is arranged on one surface of the respective bone conduction support close to the pet, and the electrode of the electric shock head passes through the bone conduction support to be connected to the electrical assembly in the main body shell structure.

Further, a second waterproof sealing ring is arranged between each of the electric shock heads and the respective bone conduction support.

With regard to the anti-barking device with the bone conduction microphones, the anti-barking device further comprises the infrared wearing detection module configured to ensure whether the anti-barking device is worn.

Further, the infrared wearing detection module comprises an infrared receiver and an infrared emitter, the infrared emitter is configured to emit an infrared ray in real time, and the infrared receiver is configured to receive the infrared ray and decode the infrared ray.

Furthermore, the infrared emitter emits the infrared ray with a rolling code in real time, the infrared receiver decodes the infrared ray after receiving the infrared ray, data comparison is performed on an obtained code after decoding and a pre-input rolling code data set of the infrared emitter, if the obtained code matches any code in the rolling code data set, it is considered a successful match, and on the contrary, it is considered an unsuccessful match.

Further, a hole is formed in one surface of the main body shell structure close to the skin of the pet, and the infrared wearing detection module passes through the hole to be connected to the electrical assembly in the main body shell structure.

With regard to the anti-barking device with the bone conduction microphones, the bone conduction microphones capture the vibrations during the barking of the pet, the bone conduction microphones convert the sensed vibration signals into the electric signals, the electric signals are sent to the microprocessor by means of the connection wires connected to the microprocessor after passing through the elastic arms and the bone conduction supports, the microprocessor receives the electric signals, generates the warning signals and sends the warning signals to the electric shock control circuits of the electric shock heads, the electric shock control circuits determine the strength and the duration of the electric shocks according to the preset mode, the electric shock control circuits start the electrodes, and the electrodes emit the electric shock stimulation to the pet.

The present invention according to the above solutions has the beneficial effects as follows: 1. accurate vibration capture: the anti-barking device uses the bone conduction microphones to sense the bone vibrations generated during the barking of the pet and convert the vibration signals to the electric signals, and such design allows the anti-barking device to more accurately capture barking behaviors of the pet to be trained instead of simply responding to sounds made by other objects, people and animals, thereby improving the training accuracy; 2. reduction of false triggering: the bone conduction microphones only respond to barking vibrations of the pet that wears the product, so that false triggering caused by barks of other pets or environmental noise can be avoided, and this is a remarkable improvement when compared with an anti-barking device only using air conduction microphones; 3. waterproof design: the waterproof sealing rings are arranged between the bone conduction supports and the main body shell structure of the anti-barking device to provide additional waterproof performance, so that the anti-barking device can be used under various environmental conditions, including in rainy days or during drinking of the pet; 4. control on the strength and the duration of the electric shocks: the electric shock heads comprise the electric shock control circuits which can determine the strength and the duration of the electric shocks according to the preset mode, and if the safety control threshold value is reached, the electric shock heads will be suspended for a period of time, which not only protects the pet, but also prolongs the product life of the electric shock heads; 5. the infrared wearing detection module: the anti-barking device comprises the infrared wearing detection module which can ensure whether the anti-barking device is correctly worn by the pet, and this function ensures that the anti-barking device only operates when being worn by the pet; 6. the adjustable elastic arms: the elastic arms are of the shape-adjustable flexible hollow structure and can adapt to necks of pets of different sizes, thereby ensuring that the bone conduction microphones can be stably fitted with the neck of the pet; 7. integration of the display screen: the display screen is arranged on the upper shell of the main body shell structure, receives the warning signals from the microprocessor, and displays different warning icons according to the different warning signals, thereby providing direct feedback for a user; and 8. consideration of the safety: the design of the anti-barking device fully considers the safety of the pet, the strength and the duration of the electric shock stimulation are controlled by means of the microprocessor, and the infrared wearing detection module is provided to ensure that the anti-barking device is correctly worn.

### BRIEF DESCRIPTION OF THE DRAWINGS

In order to explain technical solutions in embodiments of the present invention more clearly, drawings needed in descriptions of the embodiments or the prior art will be briefly introduced below. Obviously, the accompanying drawings in the following descriptions are some embodiments of the present invention, and for those of ordinary skill in the art, other drawings can be obtained according to these accompanying drawings without involving any inventive effort.

FIG. 1 is a structural schematic diagram of an anti-barking device at one viewing angle.

FIG. 2 is a structural schematic diagram of the anti-barking device at the other viewing angle.

FIG. 3 is a first structural breakdown schematic diagram of the anti-barking device.

FIG. 4 is a second structural breakdown schematic diagram of the anti-barking device.

FIG. 5 is a third structural breakdown schematic diagram of the anti-barking device.

Reference numerals in the drawings: 1. main body shell structure; 11. upper shell; 12. lower shell; 13. panel structure; 14. display screen; 15. lace opening; 2. bone conduction support; 21. first waterproof sealing ring; 22. second waterproof sealing ring;3. elastic arm; 4. bone conduction microphone; 5. electric shock head; 51. insulator; 52. electrode; 6. infrared induction head; 61. infrared receiver; 62. infrared emitter; and 63. infrared lens.

### DETAILED DESCRIPTION OF EMBODIMENTS

In order to make the technical problems to be solved by the present invention, the technical solutions and the beneficial effects more clear, the present invention is further described in detail in conjunction with accompanying drawings and embodiments below. It should be understood that the specific embodiments described herein are only used to explain the present invention, not to define the present invention.

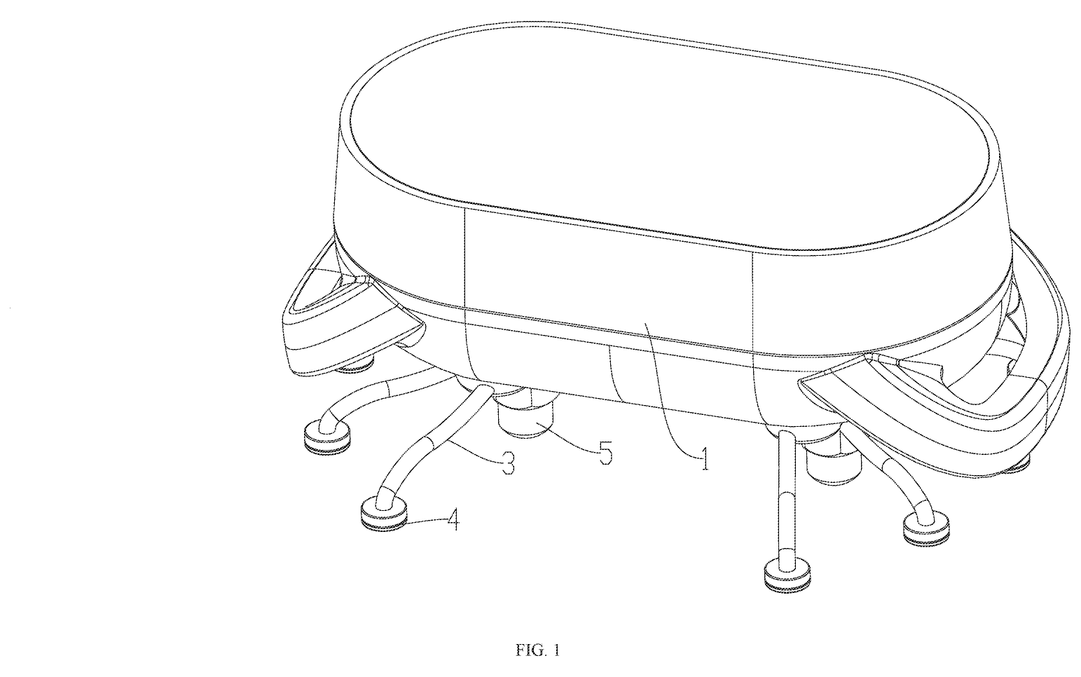

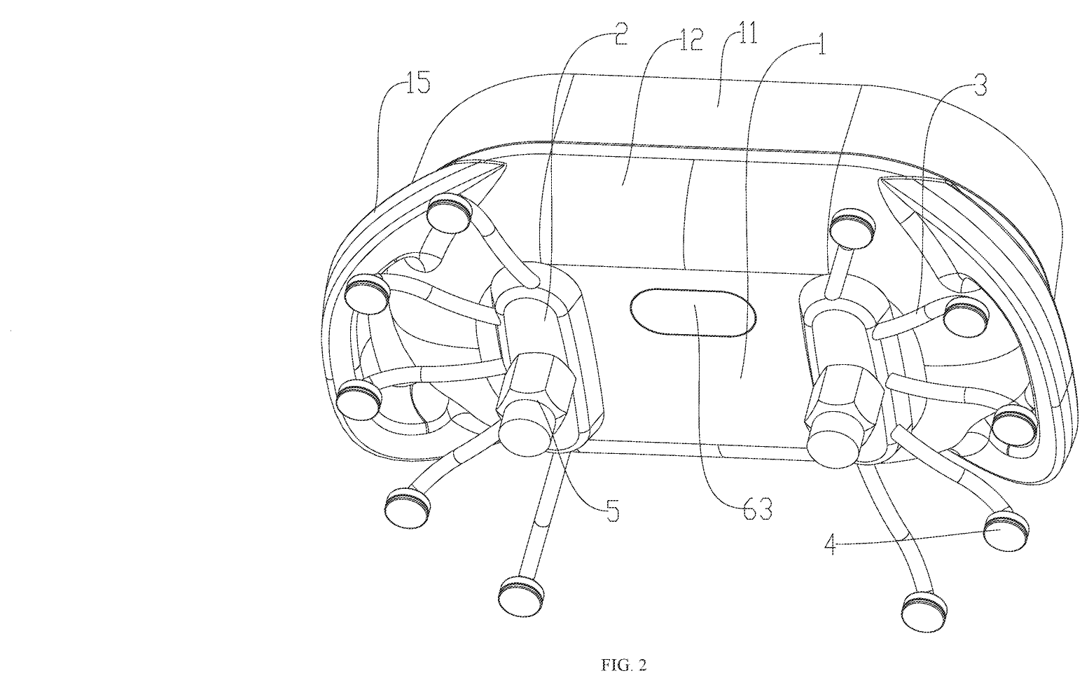

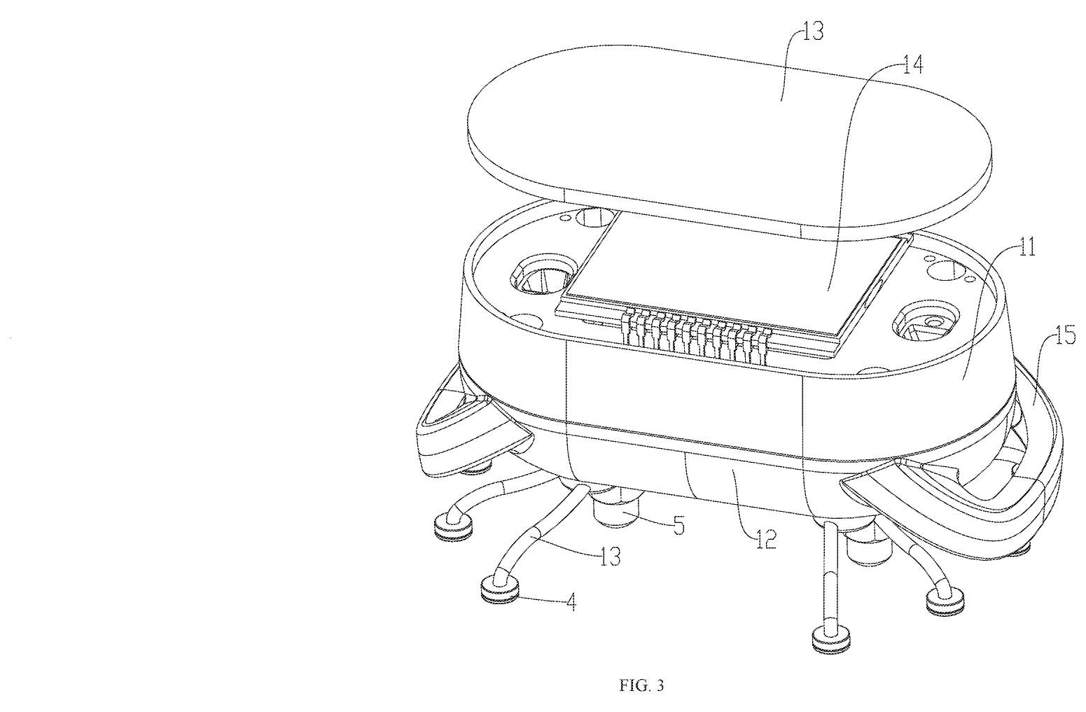

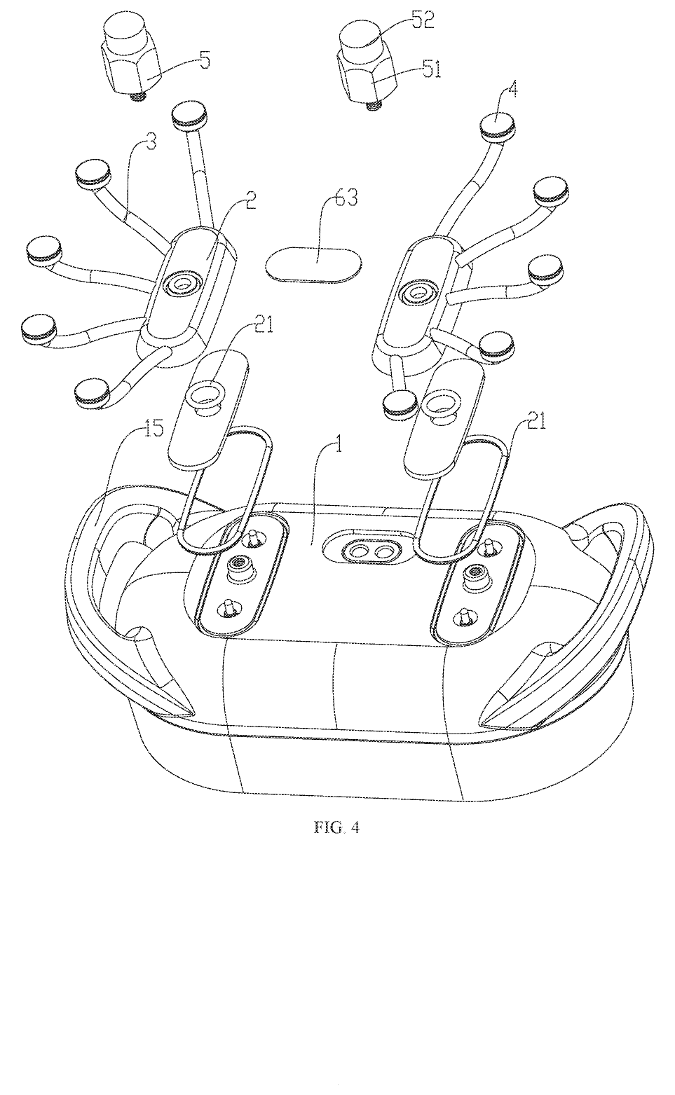

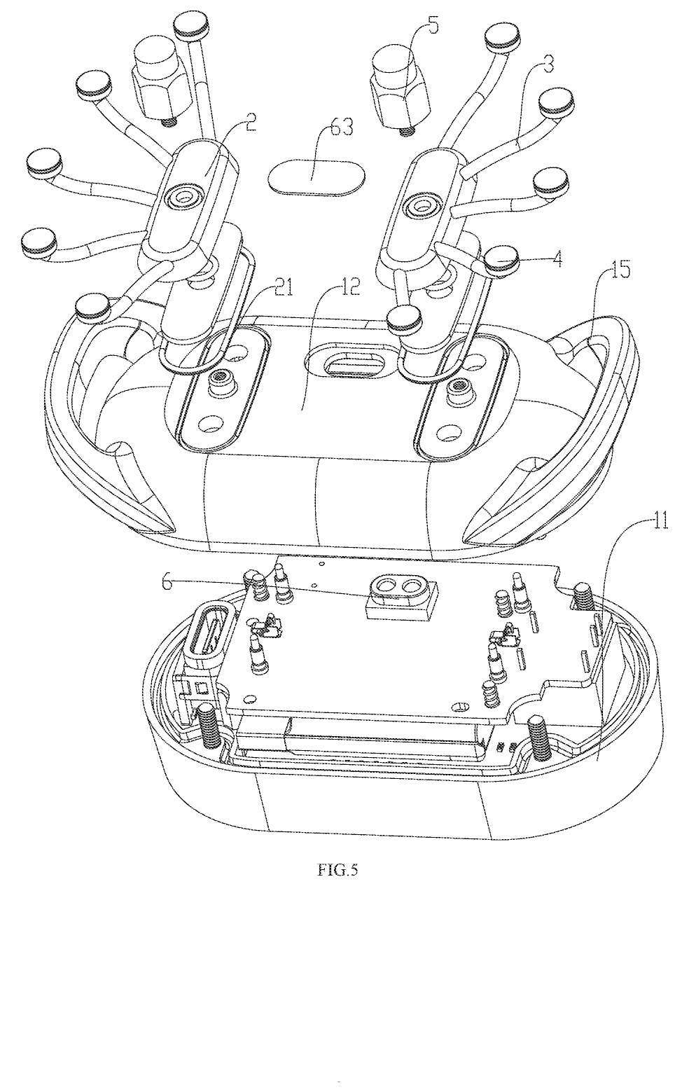

As shown in FIG. 1 to FIG. 5, an anti-barking device with bone conduction microphones includes:

a main body shell structure 1 configured to provide a mounting base and protection for other functional components and internally provided with an electrical assembly;

the electrical assembly configured to receive pet status information and real-time feedback;

elastic arms 3 configured to ensure that the bone conduction microphones 4 are stably fitted with a pet;

the bone conduction microphones 4 arranged at tail ends of the elastic arms 3 and configured to sense bone vibrations generated during barking of the pet and convert vibration signals into electric signals; and

electric shock heads 5 configured to provide electric shock stimulation during the barking of the pet.

The main body shell structure 1 includes an upper shell 11 and a lower shell 12, the upper shell 11 and the lower shell 12 are connected to form an enclosing space, and the enclosing space is internally provided with the electrical assembly.

A panel structure 13 is arranged on the upper shell 11 of the main body shell structure 1.

In this embodiment, the panel structure 13 is a waterproof crystal panel. The crystal panel is configured for waterproofness of the shell structure, a recess formed by downward recessing is formed in an upper surface of the upper shell 11, and the crystal panel is connected to the recess, so that the crystal panel is closely connected to the recess; and a sealed connection can be achieved by means of an adhesive, thereby protecting the electrical assembly below the crystal panel.

A display screen 14 is arranged on the upper shell 11 of the main body shell structure 1.

An opening is formed in the upper shell 11 of the main body shell structure 1, the display screen 14 is arranged at the opening, and the display screen 14 is arranged below the panel structure 13. In this embodiment, the display screen 14 is arranged below the crystal panel and is subjected to waterproof protection of the crystal panel. The display screen 14 receives warning signals from a microprocessor and displays different warning icons according to the different warning signals.

A connection between the upper shell 11 and the lower shell 12 is a threaded connection of bolts and screw holes.

Columnar structures with the screw holes are arranged on one of shell bodies of the upper shell 11 and the lower shell 12, round holes are formed in the other shell body, the bolts are inserted downwards into the screw holes from the round holes to complete the threaded connection of the bolts and the screw holes, and heads of the bolts are clamped on the other shell body, thereby connecting the upper shell 11 to the lower shell 12.

Bone conduction supports 2 are arranged on one surface of the main body shell structure 1 close to the skin of the pet, and the bone conduction supports 2 are configured for the mounting base for the elastic arms 3 and the electric shock heads 5 and the protection of related electronic components.

Functional components such as the bone conduction microphones 4 and the electric shock heads 5 need to be arranged on the surface of the main body shell structure 1 close to the skin of the pet, and the two kinds of functional components have the structural irregular and adjustable space requirements. In addition, the electric shock heads 5 also have certain requirements for waterproof and sealing performance. Therefore, the protruding bone conduction supports 2 are arranged on the surface of the main body shell structure 1 close to the skin of the pet, serve as mounting bases for the elastic arms 3 and the electric shock heads 5, and provide waterproof and sealed accommodating spaces for connection structures between the functional components such as the bone conduction microphones 4 and the electric shock heads 5 and the electrical assembly in the main body shell structure 1.

Symmetric concave structures are arranged on one surface of the main body shell structure 1 close to the skin of the pet, and the bone conduction supports 2 are arranged outside the concave structures, so that enclosing spaces are formed between the bone conduction supports 2 and the concave structures.

A plurality of connection holes are formed in the concave structures, and connection wires of electronic components in the enclosing spaces formed between the bone conduction supports 2 and the concave structures and the electrical assembly in an internal space of the main body shell structure 1 pass through the connection holes.

A first waterproof sealing ring 21 is arranged between each of the bone conduction supports 2 and the main body shell structure 1. An edge of each of the concave structures is further recessed to form an annular groove, the first waterproof sealing ring 21 is arranged in the annular groove, so that waterproof sealing is achieved between the bone conduction support 2 and the main body shell structure 1.

Lace openings 15 are formed on two sides of the main body shell structure 1.

The main body shell structure 1 needs to be worn on the body of the pet, mainly at the neck of the pet, and is usually worn by means of a material the same as or similar to a collar, so that the main body shell structure 1 is provided with the lace openings 15 configured to connect strip-shaped structures for wearing. In addition, the lace openings 15 are in a shape inclined towards a pet end, so that a certain space is made between the body of the pet and the main body shell structure 1 to accommodate the elastic arms 3 and the electric shock heads 5.

The electrical assembly includes:

the microprocessor configured to receive the electric signals sent by the bone conduction microphones 4 and send the warning signals to the electric shock heads 5.

The bone conduction microphones 4 capture the vibrations during the barking of the pet, the bone conduction microphones 4 convert the sensed vibration signals into the electric signals, the electric signals are sent to the microprocessor by means of the connection wires connected to the microprocessor after passing through the elastic arms 3 and the bone conduction supports 2, the microprocessor receives the electric signals, generates the warning signals and sends the warning signals to electric shock control circuits of the electric shock heads 5, the electric shock control circuits determine the strength and the duration of the electric shocks according to the preset mode, the electric shock control circuits start electrodes 52, and the electrodes 52 emit the electric shock stimulation to the pet, thereby enhancing the training effect. Under such circumstance, if the bone conduction microphones 4 continuously capture the vibrations during the barking of the pet, the microprocessor receives the continuous electric signals, and the microprocessor gradually changes commands carried by the warning signals according to a preset warning threshold value, so that the electric shock control circuits adjust the used preset mode, thereby enhancing the strength of the electric shocks and prolonging the duration of the electric shocks, and further enhancing the training effect. Of course, for the safety of the pet, each of the electric shock control circuits controls the strength and the duration of the electric shocks sent by the respective electric shock head 5, if a safety control threshold value is reached, the electrode 52 of the electric shock head 5 is suspended for certain set time, and the mode is also capable of protecting the electric shock head 5 against overwork and prolonging the product life of the electric shock head 5.

The microprocessor further receives matching signals fed back by an infrared wearing detection module, when the infrared wearing detection module sends a signal of successful matching, the microprocessor starts to work and begins to process the received electric signals sent by the bone conduction microphones 4, and when the infrared wearing detection module sends a signal of unsuccessful matching, the microprocessor does not start to work.

The electrical assembly further includes a power source configured to supply power.

The electrical assembly further includes a transformer configured to change a power supply voltage of the power source for a certain component.

Each of the elastic arms 3 is of an adjustable flexible hollow structure.

An inner cavity of each of the elastic arms 3 is in communication with the respective bone conduction support 2.

There are eight elastic arms 3.

The elastic arms 3 are of the elongated elastic hollow structure made of a flexible material, and the structure thereof allows bending, extension and retraction to a certain extent and can change the shape with adjusting actions such as twisting and pulling so as to adapt to the necks of pets in different sizes, thereby ensuring that the bone conduction microphones 4 can be stably fitted with the neck of the pet to accurately capture the vibration signals generated during the barking.

The respective bone conduction microphone 4 is fixed to one end of each elastic arm 3, and the other end is connected to the respective bone conduction support 2. The elastic arms 3 and the bone conduction microphones 4 can be connected in an embedded manner, or mechanically locked, or fixed by means of an adhesive, so that the bone conduction microphones 4 can be fixed to the tail ends of the elastic arms 3 and closely fitted with the neck of the pet with adjustment of the elastic arms 3. The bone conduction microphones 4 are arranged at the tail ends of the elastic arms 3. The bone conduction microphones 4 are of a flat cylindrical structure and are arranged at the tail ends of the elastic arms 3 in a structure similar to “floating plates” at tail ends of long legs of an insect, thereby increasing the area of a plane in contact with the skin of the pet. The other ends of the elastic arms 3 can be connected to the bone conduction supports 2 by means of clamping groove fitting or thread fastening, thereby facilitating mounting and dismounting.

With regard to the hollow design of the elastic arms 3, on one hand, the weight can be reduced, and meanwhile, the sufficient strength and durability are maintained; and on the other hand, an electrical connection wire of each of the bone conduction microphones 4 passes through an internal hollow structure of the respective elastic arm 3 to extend into the enclosing space between the respective bone conduction support 2 and the respective concave structure and is electrically connected to the electronic components in the bone conduction support 2.

The elastic arms 3 can be manufactured by means of a plastic injection molding technology, then heat treatment is performed to enhance the elasticity thereof, and frosting or sand blasting treatment can be performed on surfaces, thereby increasing the friction force with the neck of the pet to prevent slipping.

The elastic arms 3 are symmetrically arranged on two sides of the main body shell structure 1 to form a mirror-symmetric structure, thereby achieving the contact stability with the body of the pet. The specific number of the elastic arms 3 is uncertain, is usually an even number, and is eight in this embodiment.

The elastic arms 3 play a crucial role, provide necessary mechanical support for the bone conduction microphones 4 to enable the bone conduction microphones 4 to operate stably, and improve the comfort level of the pet when wearing the anti-barking device by means of the elastic design thereof. In addition, the hollow design of the elastic arms 3 also considers the durability and the waterproofness, so as to adapt to the need of the pet for outdoor activities.

Each of the bone conduction microphones 4 includes:

a piezoelectric element configured to sense the vibrations; and

a signal processing circuit configured to convert the vibration signals obtained by the piezoelectric element into the electric signals, and connected to the electronic components in the respective bone conduction support 2 by a connection wire passing through the respective elastic arm 3.

The bone conduction microphones 4 are core components for achieving the function of the anti-barking device, accurately capture the vibrations during the barking of the pet, and convert the vibrations into the electric signals for analysis and processing by the microprocessor arranged in the main body shell structure 1. Use of the bone conduction microphones 4 can reduce false triggering caused by animals not to be trained, thereby improving the reliability and effectiveness of the anti-barking device.

Each of the electric shock heads 5 usually includes:

the electrode 52 configured to transmit the electric shock stimulation to the pet;

an insulator 51 configured to coat or isolate the electrode 52; and

the electric shock control circuit configured to control the strength and the duration of the electric shocks of the electrode 52.

Each of the electric shock heads 5 is arranged on one surface of the respective bone conduction support 2 close to the pet, and the electrode 52 (a structure with a thread) of the electric shock head 5 passes through the bone conduction support 2 to be connected to the electrical assembly in the main body shell structure 1.

A second waterproof sealing ring 22 is arranged between each of the electric shock heads 5 and the respective bone conduction support 2.

The insulators 51 coat or isolate the electrodes 52 to prevent short-circuiting or accidental contact, and the electric shock control circuits control the strength and the duration of the electric shocks of the electrodes 52. By controlling the strength and the duration of the electric shocks, the electric shock heads 5 can help an owner of the pet more effectively manage and train the pet, and ensure the safety and welfare of the pet at the same time.

The electrodes 52 of the electric shock heads 5 are made of metal sheets or electrically-conductive rubber, the insulators 51 are made of plastic or silicone materials, and the electric shock control circuits are assembled on small circuit boards by means of a surface mounting technology (SMT). The electric shock heads 5 are connected to the bone conduction supports 2 by means of threaded connection or clamping groove structures, thereby ensuring that the electric shock heads 5 can be stably mounted on a main body of the anti-barking device and in contact with the skin of the pet.

The anti-barking device further includes the infrared wearing detection module configured to ensure whether the anti-barking device is worn.

The infrared wearing detection module includes an infrared receiver 61 and an infrared emitter 62, the infrared emitter 62 is configured to emit an infrared ray in real time, and the infrared receiver 61 is configured to receive the infrared ray and decode the infrared ray.

The infrared emitter 62 emits the infrared ray with a rolling code in real time, the infrared receiver 61 decodes the infrared ray after receiving the infrared ray, data comparison is performed on an obtained code after decoding and a pre-input rolling code data set of the infrared emitter 62, and if the obtained code matches any code in the rolling code data set, it is considered a successful match. When the anti-barking device is worn on the neck of the pet, the infrared ray emitted by the infrared emitter 62 will be reflected back, the infrared receiver 61 receives the infrared ray, if the infrared receiver 61 decodes and matches the received infrared ray successfully, it means that the anti-barking device is worn successfully, and on the contrary, if the matching is unsuccessful, it means that the anti-barking device is worn unsuccessfully.

In this embodiment, a hole is formed in one surface of the main body shell structure 1 close to the skin of the pet, an infrared induction head 6 (that is, the infrared wearing detection module) passes through the hole to be connected to the electrical assembly in the main body shell structure 1, and an infrared lens 63 is arranged on a surface of the infrared induction head 6 for protection.

The above are only the preferred embodiments of the present invention, and do not limit the present invention. Any modification, equivalent replacement and improvement made within the spirit and principles of the present invention should fall within the scope of protection of the present invention.

What is claimed is:

1. An anti-barking device with bone conduction microphones, comprising:
a main body shell structure configured to provide a mounting base and protection for other functional components and internally provided with an electrical assembly;
the electrical assembly configured to receive pet status information and real-time feedback;
elastic arms configured to ensure that the bone conduction microphones are stably fitted with a pet;
the bone conduction microphones arranged at tail ends of the elastic arms and configured to sense bone vibrations generated during barking of the pet and convert vibration signals into electric signals; and
electric shock heads configured to provide electric shock stimulation during the barking of the pet.

2. The anti-barking device with bone conduction microphones according to claim 1, wherein the main body shell structure comprises an upper shell and a lower shell, the upper shell and the lower shell are connected to form an enclosing space, and the enclosing space is internally provided with the electrical assembly.

3. The anti-barking device with bone conduction microphones according to claim 2, wherein a panel structure is arranged on the upper shell of the main body shell structure.

4. The anti-barking device with bone conduction microphones according to claim 2, wherein a display screen is arranged on the upper shell of the main body shell structure.

5. The anti-barking device with bone conduction microphones according to claim 1, wherein bone conduction supports are arranged on one surface of the main body shell structure close to the skin of the pet, and the bone conduction supports are configured for the mounting base for the elastic arms and the electric shock heads and the protection of related electronic components.

6. The anti-barking device with bone conduction microphones according to claim 5, wherein a first waterproof sealing ring is arranged between each of the bone conduction supports and the main body shell structure.

7. The anti-barking device with bone conduction microphones according to claim 1, wherein the electrical assembly comprises:
a microprocessor configured to receive the electric signals sent by the bone conduction microphones and send warning signals to the electric shock heads.

8. The anti-barking device with bone conduction microphones according to claim 7, wherein the microprocessor further receives matching signals fed back by an infrared wearing detection module, when the infrared wearing detection module sends a signal of successful matching, the microprocessor starts to work and begins to process the received electric signals sent by the bone conduction microphones, and when the infrared wearing detection module sends a signal of unsuccessful matching, the microprocessor does not start to work.

9. The anti-barking device with bone conduction microphones according to claim 7, wherein the microprocessor further sends the warning signals to a display screen.

10. The anti-barking device with bone conduction microphones according to claim 1, wherein each of the elastic arms is of a shape-adjustable flexible hollow structure.

11. The anti-barking device with bone conduction microphones according to claim 1, wherein an electrical connection wire of each of the bone conduction microphones passes through an internal hollow structure of the respective elastic arm to extend into an enclosing space between a bone conduction support and a concave structure and is electrically connected to electronic components in the bone conduction support.

12. The anti-barking device with bone conduction microphones according to claim 1, wherein each of the bone conduction microphones comprises:
a piezoelectric element configured to sense the vibrations; and
a signal processing circuit configured to convert the vibration signals obtained by the piezoelectric element into the electric signals, and connected to electronic components in a bone conduction support by a connection wire passing through the respective elastic arm.

13. The anti-barking device with bone conduction microphones according to claim 1, wherein each of the electric shock heads usually comprises:
an electrode configured to transmit the electric shock stimulation to the pet;
an insulator configured to coat or isolate the electrode; and
an electric shock control circuit configured to control strength and a duration of electric shocks of the electrode.

14. The anti-barking device with bone conduction microphones according to claim 13, wherein each of the electric shock control circuits controls the strength and the duration of the electric shocks sent by the respective electric shock head, if a safety control threshold value is reached, the electrode of the electric shock head is suspended for certain set time, and the mode is also capable of protecting the electric shock head against overwork and prolonging the product life of the electric shock head.

15. The anti-barking device with bone conduction microphones according to claim 1, wherein each of the electric shock heads is arranged on one surface of a bone conduction support close to the pet, and an electrode of the electric shock head passes through the bone conduction support to be connected to the electrical assembly in the main body shell structure.

16. The anti-barking device with bone conduction microphones according to claim 15, wherein a second waterproof sealing ring is arranged between each of the electric shock heads and the respective bone conduction support.

17. The anti-barking device with bone conduction microphones according to claim 1, further comprising an infrared wearing detection module configured to ensure whether the anti-barking device is worn.

18. The anti-barking device with bone conduction microphones according to claim 17, wherein the infrared wearing detection module comprises an infrared receiver and an infrared emitter, the infrared emitter is configured to emit an infrared ray in real time, and the infrared receiver is configured to receive the infrared ray and decode the infrared ray.

19. The anti-barking device with bone conduction microphones according to claim 17, wherein an infrared emitter emits an infrared ray with a rolling code in real time, an infrared receiver decodes the infrared ray after receiving the infrared ray, data comparison is performed on an obtained code after decoding and a pre-input rolling code data set of the infrared emitter, if the obtained code matches any code in the rolling code data set, it is considered a successful match, and on the contrary, it is considered an unsuccessful match.

20. The anti-barking device with bone conduction microphones according to claim 1, wherein the bone conduction microphones capture the vibrations during the barking of the pet, the bone conduction microphones convert the sensed vibration signals into the electric signals, the electric signals are sent to a microprocessor by means of connection wires connected to the microprocessor after passing through the elastic arms and bone conduction supports, the microprocessor receives the electric signals, generates warning signals and sends the warning signals to electric shock control circuits of the electric shock heads, the electric shock control circuits determine strength and a duration of electric shocks according to a preset mode, the electric shock control circuits start electrodes, and the electrodes emit the electric shock stimulation to the pet.
